(19) United States
(12) Patent Application Publication
(10) Pub. No.: US 2011/0138335 A1
(43) Pub. Date: Jun. 9, 2011

(54) THIN ANALYTICS FOR ENTERPRISE MOBILE USERS

(75) Inventors: Geogy Zacariah, Singapore (SG); Zhang Jie, Singapore (SG)

(73) Assignee: Sybase, Inc., Dublin, CA (US)

(21) Appl. No.: 12/632,963

(22) Filed: Dec. 8, 2009

(51) Int. Cl. G06F 3/048

(52) U.S. Cl. 715/843; 715/764

(57) ABSTRACT

A system, method, and computer program product are provided for creating expressions through the use of an expression builder. This allows the exploitation of additional views of data in a local data store without the need to rely on an enterprise server to push this data to a user device. Meta data descriptions of a local data source as properties are provided in order to generate an expression builder interface which can be used to combine these properties with mathematical expressions to derive new views of the local data.

### BACKGROUND OF INVENTION

1. Field of the Invention

The present invention relates generally to mobile devices, and, more specifically, to data views of locally stored data.

2. Description of the Background Art

Mobile devices continue to become prevalent in the field, where many individuals from diverse occupations rely on the devices to provide relevant and understandable data. Some subset of the universe of data is commonly downloaded, or synchronized, to these mobile devices for access in the field.

Many of these mobile devices are then used in areas where they cannot remain permanently connected to the source of the data download, such as to an enterprise server. As a result, the mobile devices must present data to the user based only on what they have locally available.

Should a user require a particular set of information, even that which could be derived from other data in the database, it is generally required that the data source push this information down to the mobile device at the next synchronization opportunity. This results in a missed opportunity to derive information from the locally available data and to expose all facets of this data.

Accordingly, what is desired is analytics software which is useable on the dataset of a thin mobile device.

### SUMMARY OF INVENTION

Embodiments of the invention include a method comprising accessing, in one or more processors, a meta data description of a data source, the meta data description comprising data properties, providing, in the one or more processors, an expression builder interface comprising a listing of the data properties and mathematical expressions usable in conjunction with the data properties, receiving, in the one or more processors, an expression composed through the expression builder, and graphically outputting, from the one or more processors to a display device, a representation of the expression based on data from the data source.

Further embodiments of the invention include a computer-readable medium having computer-executable instructions stored thereon that, if executed by a computing device, cause the computing device to perform a method. The method includes accessing a meta data description of a data source, the meta data description comprising data properties, providing an expression builder interface comprising a listing of the data properties and mathematical expressions usable in conjunction with the data properties, receiving an expression composed through the expression builder, and graphically outputting a representation of the expression based on data from the data source.

Additional embodiments of the present invention include a system comprising a memory configured to store modules comprising an accessing module configured to access a meta data description of a data source, the meta data description comprising data properties, a providing module configured to provide an expression builder interface comprising a listing of the data properties and mathematical expressions usable in conjunction with the data properties, a receiving module configured to receive an expression composed through the expression builder, and an outputting module configured to graphically output a representation of the expression based on data from the data source, and one or more processors configured to process the modules.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is an enterprise network, in accordance with an embodiment of the present invention.

FIG. 2 is a system for a mobile device for developing and presenting thin analytics, in accordance with an embodiment of the present invention.

FIG. 3 is a view of a graphical user interface on which thin analytics are displayed, in accordance with an embodiment of the present invention

FIG. 4A is a graph view showing sales data, in accordance with an embodiment of the present invention.

FIG. 4B shows graph view where the drop-down menu has been selected, in accordance with an embodiment of the present invention.

FIG. 5 shows a graphical user interface displaying a context menu, in accordance with an embodiment of the present invention.

FIG. 6 is a graphical user interface where the quarterly profit graph is shown in the form of a bar chart, in accordance with an embodiment of the present invention.

FIG. 7A is a graphical user interface of an expression builder showing the parameters and expressions by which the “Quarterly Sales Quantity Graph” is derived, in accordance with an embodiment of the present invention.

FIG. 7B is another view of a graphical user interface of an expression builder where “Quarterly Sales Revenue Graph” has been selected from the drop-down menu, in accordance with an embodiment of the present invention.

FIG. 8A is an advanced expression builder editing expressions for a category, in accordance with an embodiment of the present invention.

FIG. 8B is an advanced expression builder editing expressions for a series, in accordance with an embodiment of the present invention.

FIG. 8C is an advanced expression builder editing expressions for a value, in accordance with an embodiment of the present invention.

FIG. 9 is a flowchart illustrating steps by which a user is able to view a defined expression, in accordance with an embodiment of the present invention.

FIG. 10 is a flowchart illustrating steps by which the expression builder interface is usable to create an expression, in accordance with an embodiment of the present invention.

FIG. 11 is a flowchart illustrating steps by which user roles control access to the thin analytics application, in accordance with an embodiment of the present invention.

FIG. 12 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

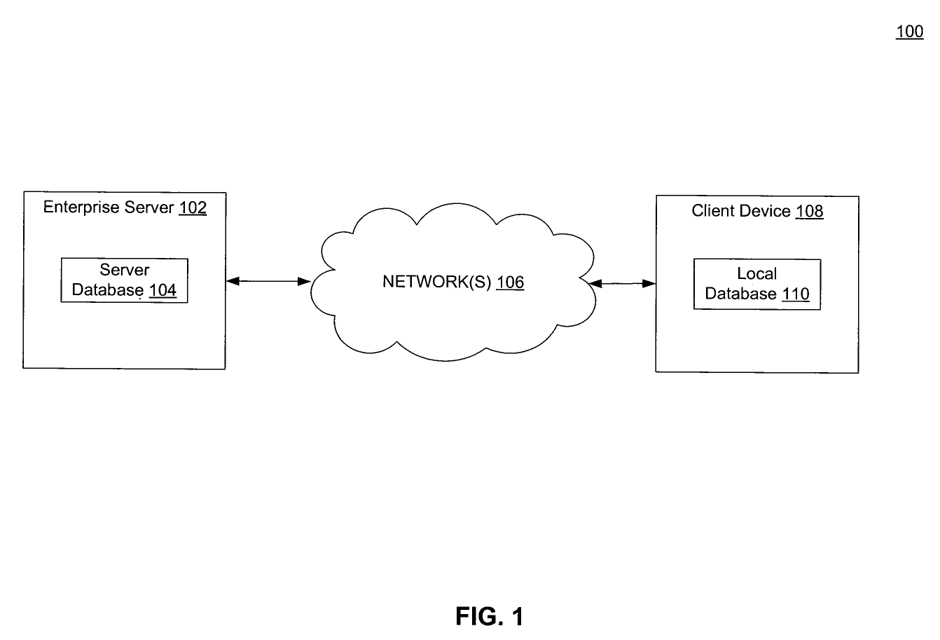

FIG. 1 is an enterprise network 100, in accordance with an embodiment of the present invention. Enterprise network 100 comprises an enterprise server 102 housing a server database 104. The enterprise server 102 is connected via network 106 to client device 108. Client device 108 has a local database 110. One skilled in the relevant arts will recognize that network 106 can be one of many different types of networks which are used to establish communications between an enterprise server 102 and client device 108, including, but not limited to, the Internet or a corporate intranet.

In accordance with an embodiment of the present invention, client device 108 is a mobile device. Such mobile devices suffer from limitations such as reduced memory capabilities when compared to the enterprise server 102. Therefore, local database 110 will generally store a subset of the data found at server database 104. In accordance with a further embodiment of the present invention, the data available at local database 110 can be synchronized with server database 104. A particular embodiment by which client device 108 can interact with enterprise server 102 to synchronize data is described in U.S. patent application Ser. No. 11/882,749, filed Aug. 3, 2007, titled “Unwired Enterprise Platform” (Atty. Dkt. No. 1933.0430000), which is herein incorporated by reference in its entirety. One skilled in the relevant arts will appreciate that other means exist by which to provide data to local database 110.

Another limitation generally encountered by mobile devices, such as client device 108, is lack of continuous access to a central data store, such as server database 104. This results in the isolated client device 108 generally losing the capability to show different views of data provided by the enterprise server 102.

### II. Thin Analytics System

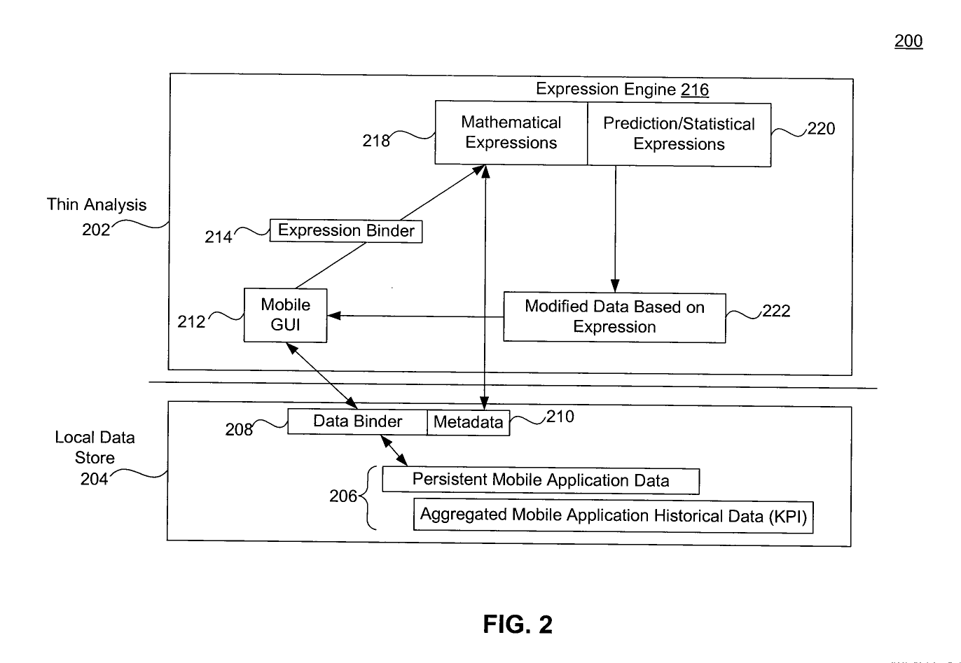

FIG. 2 is a system 200 for a mobile device for developing and presenting thin analytics, in accordance with an embodiment of the present invention. The terminology “thin analytics” in this context is used to identify analytics performed on a thin client device, such as a mobile handheld device, where “thin” denotes a device or application with at least some features (e.g., memory, processor, functionality, etc.) that have less capacity and/or capability relative to other devices or applications.

A thin analytics application 202 is coupled in the system to a local data store 204, in accordance with an embodiment of the present invention. Local data store 204 is a lightweight database holding some subset of data from an enterprise server database, such as database 104 of FIG. 1, in accordance with an embodiment of the present invention. The local data store 204 will have an opportunity to receive up-to-date data on occasion, and then may be expected to operate in a disconnected state. For example, a manager may take a mobile device having sales numbers stored on the local data store 204, but may not have connectivity in order to synchronize with the enterprise while out in the field.

Throughout the specification, local data store 204 will be treated as a relational database by way of example, and not limitation. One skilled in the relevant arts will appreciate that other data storage and retrieval mechanisms may be substituted for local data store 204.

The local data store 204 is comprised of persistent mobile application data and aggregated mobile application historical data (e.g., aggregated key performance indicators, or “KPI”), shown as element 206. Data from these sources (e.g., a column from a database in local data store 204) can be bound to by data binder 208, through the use of meta data 210 (e.g., by parsing and interpreting the relationships established by the meta data 210), in accordance with an embodiment of the present invention. Meta data 210 provides a description of the data 206 to thin analytics application 202 which can be used to bind particular elements to an expression, in accordance with an embodiment of the present invention, which is further described below. This allows, for example, a column of the database of local data store 204 to be bound to an expression in thin analytics application 202 so that updates to the column can be received by the application.

On the thin analytics application 202 side of the system, a graphical user interface (“GUI”) 212 is presented to a user of the mobile device, in accordance with an embodiment of the present invention. One skilled in the relevant arts will appreciate that other interfaces may be used, and graphical inputs and outputs to the mobile device are presented by way of example, and not limitation.

Mobile GUI 212 allows the creation of an expression, in accordance with an embodiment of the present invention. This is accomplished by binding an expression 214 through the use of expression engine 216, in accordance with an embodiment of the present invention. Expression engine 216 uses the meta data 210 definitions of the underlying data 206, plus a set of expressions, to provide a user with the ability to create their own expressions.

The range of expressions include mathematical expressions 218 as well as prediction and statistical expressions 220. One skilled in the relevant arts will appreciate that other expression types may be implemented to create new views of data 206, and the aforementioned expressions are presented by way of example, and not limitation.

Once a user has created an expression, the data 206 is modified by the expression 222 and provided back to mobile GUI 212. The results of this expression is then displayed on the mobile device, in accordance with an embodiment of the present invention.

### III. Viewing Expressions Graphically

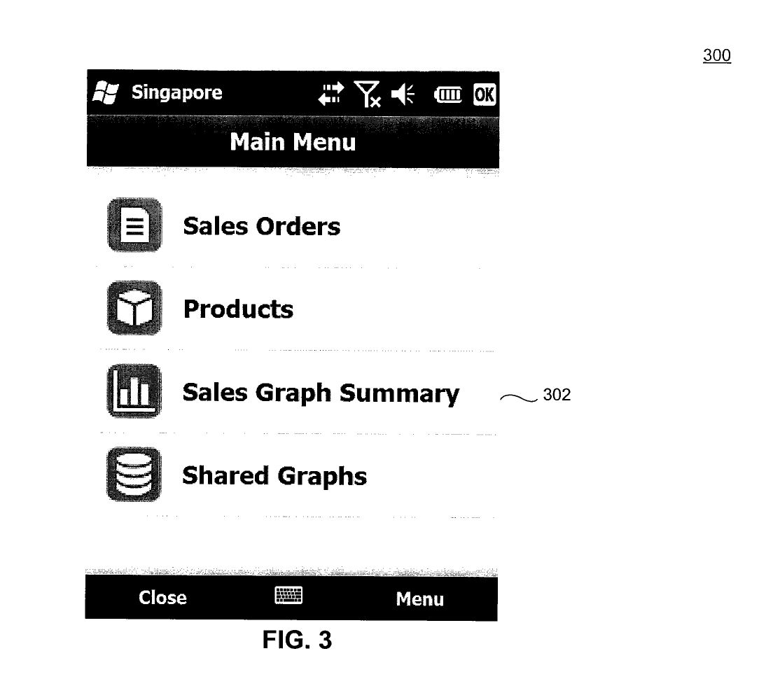

FIG. 3 is a view of a graphical user interface 300, such as GUI 212, on which thin analytics 212 are displayed, in accordance with an embodiment of the present invention. GUI 300 is a view of thin analytics presented on a Microsoft® Windows Mobile® device by way of example, and not limitation. One skilled in the relevant arts will appreciate that the principles described herein can be applied to applications developed for other platforms, such as the Apple® iPhone® or RIM® Blackberry®.

GUI 300 shows the main screen of an application used to display sales data, in accordance with an embodiment of the present invention. For example, a manager out in the field may have a mobile device running GUI 300 to provide data requested by a potential client on the spot. Sales graph summary link 302 takes the application into a display where sales data is presented in graphical form, in accordance with an embodiment of the present invention. One skilled in the relevant arts will appreciate that the use of sales data is presented by way of example, and not limitation, and the principles described herein can be applied to a vast range of data available to the analytics application.

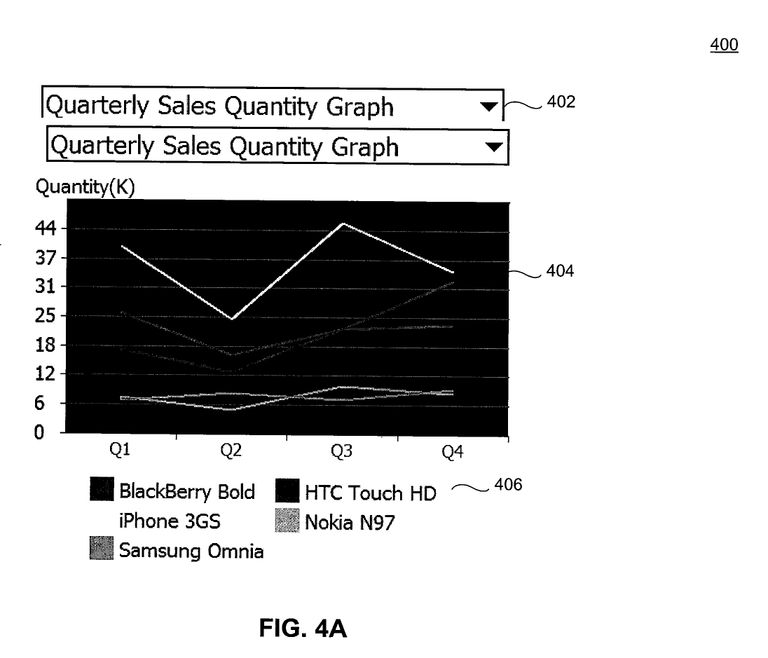

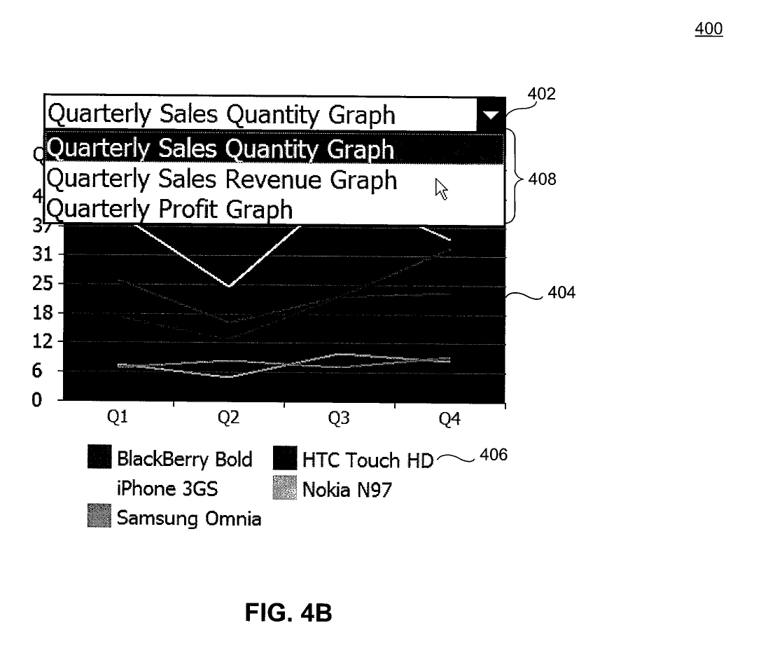

FIG. 4A is a graph view 400 showing sales data, which is displayed upon selection of the sales graph summary link 302, in accordance with an embodiment of the present invention. A drop-down menu 402 allows a user to select the data to be graphed. In this case, the “Quarterly Sales Quantity Graph” is chosen for display. Graph 404 displays the quarterly sales data, and a legend 406 indicates what each line in the graph 404 represents, in this case the sales of several handheld devices.

Graph 404 shows four quarters of data along the x-axis (“category”) and the sales quantities for each quarter on the y-axis (“value”) in 1000s (“K”) of units. Each product name entry, such as, e.g., “iPhone 3GS”, corresponds to a different line (“series”) on the graph.

FIG. 4B shows graph view 400 where the drop-down menu 402 has been selected, in accordance with an embodiment of the present invention. This reveals additional graphs 408 available for selection. In FIG. 4B, the additional graphs shown are the “Quarterly Sales Revenue Graph” and “Quarterly Profit Graph.” Selecting either of these graphs presents a user with a relevant view of the data.

By having these graphs available, a user can quickly access the fixed local data store and view the available data in different ways. As will be further described in Section V, a user may be associated with a particular role, which would allow the user access to particular views of the data store. For example, a sales manager may have the graphs shown in FIG. 4B available to view, while another user may have views showing the number of units remaining in inventory, or some other view of the data, in accordance with an embodiment of the present invention. The particular views of data available to a user help customize the interface in a manner which is best suited to that individual's needs, or based on the needs of a department to which the user belongs.

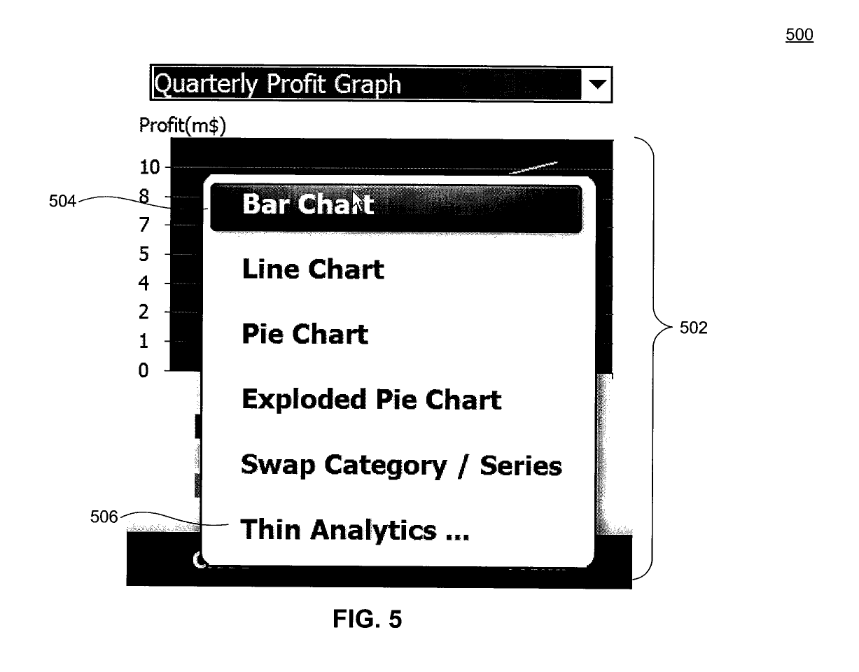

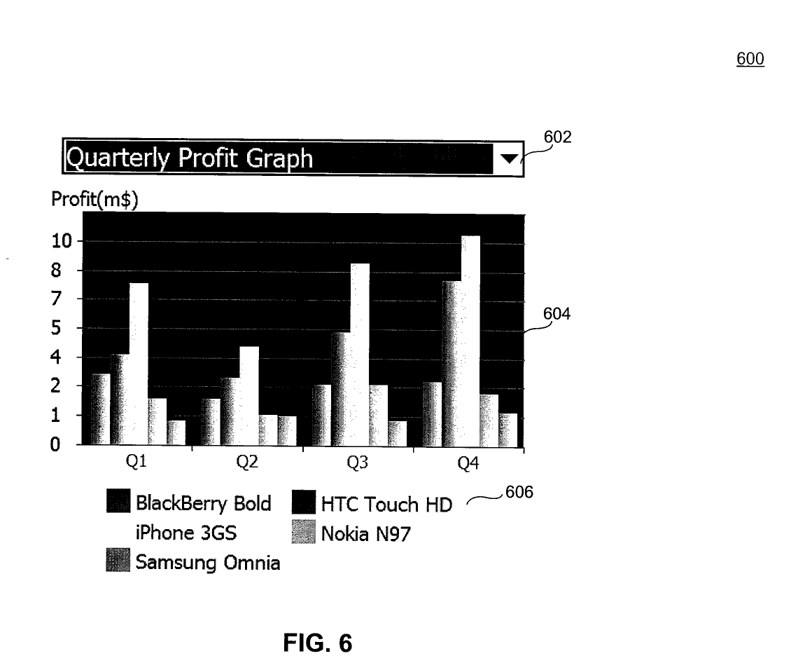

FIG. 5 shows a graphical user interface 500 displaying a context menu 502, in accordance with an embodiment of the present invention. Context menu 502 provides a number of options, such as those shown in FIG. 5, for customizing the display of graph 404 of FIG. 4. For example, a user may elect to shown graph data in the form of a bar chart by selecting “Bar Chart” button 504, in accordance with an embodiment of the present invention. This leads to a display such as shown in graphical user interface 600 of FIG. 6, where the quarterly profit graph 602 is shown in the form of a bar chart 604, in accordance with an embodiment of the present invention.

One skilled in the relevant arts will appreciate that context menu 502 may be arranged to include additional or fewer options, and may be accessed differently depending on the mobile device platform on which the analytics application has been built.

### IV. Expression Builder Interface

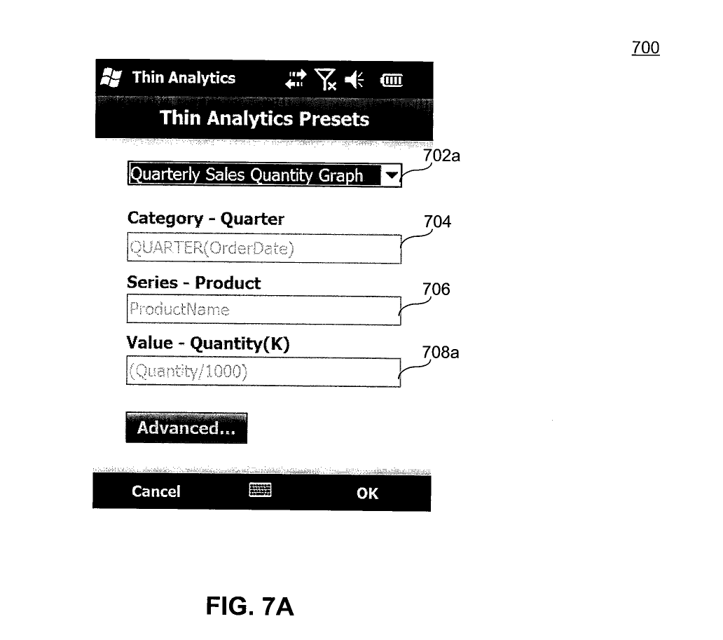

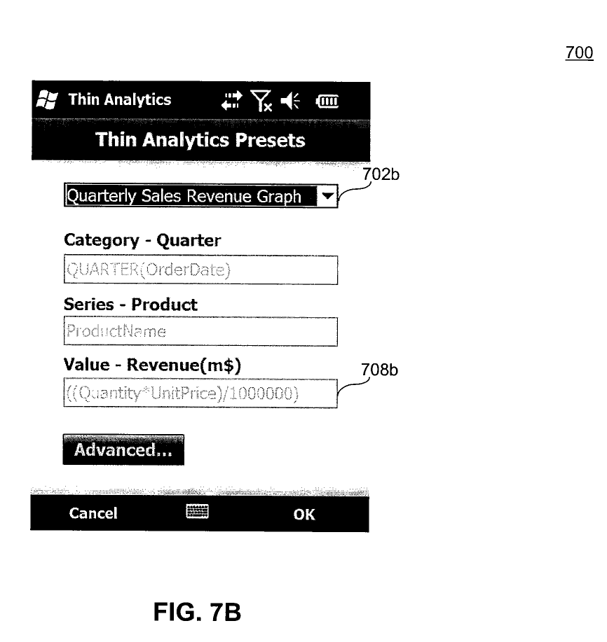

Returning now to FIG. 5, context menu 502 further contains a “Thin Analytics” button 506, which allows for the further customization of the various graph views. The selection of button 506 takes the user to graphical user interface 700 of FIG. 7A, in accordance with an embodiment of the present invention.

As will be further detailed below in Section V, not all users may have access to the screens detailed herein, which are part of the Expression Builder Interface, in accordance with an embodiment of the present invention. For example, the various views may be built for a user of the handheld device by a developer, and the user may not be permitted to modify the views. The following assumes, in an embodiment where role restrictions have been implemented, that the user has the proper access to navigate the Expression Builder interface.

Graphical user interface 700 of FIG. 7A shows the parameters and expressions by which the “Quarterly Sales Quantity Graph” is derived, in accordance with an embodiment of the present invention. This view is compared to graph view 400 of FIG. 4A. As noted above, graph 404 shows four quarters of data along the x-axis (“category”) and the sales quantities for each quarter on the y-axis (“value”) in 1000s (“K”) of units. Each product name entry, such as, e.g., “iPhone 3GS”, corresponds to a different line (“series”) on the graph.

These values can be compared to those shown in GUI 700 of FIG. 7A. The category shown in element 704 corresponds to a quarter (e.g., Q1, Q2, Q3, Q4 based on an “OrderDate”. In the example, the particular quarter is calculated through the use of an expression which calls a QUARTER function, which accepts the “OrderDate” as a parameter. By way of example, and not limitation, the underlying local database may store the order date of a product in a field called “OrderDate.” Similarly, the availability of a field called “ProductName” allows the selection of the field as the series 706.

The value field 708a shows an expression “Quantity/1000” because, in the example, the value is displayed in 1000s of units. This can be seen along the y-axis of FIG. 4A. This expression can be manually entered into field 708a. The expression corresponds to the “Quarterly Sales Quantity Graph” as selected in drop-down 702a, and would result in the graphing of quarterly sales quantities.

FIG. 7B is another view of graphical user interface 700 where “Quarterly Sales Revenue Graph” has been selected from the drop-down menu, in accordance with an embodiment of the present invention. The value field 708b has been updated to reflect the corresponding expression for this graph, specifically “(Quantity*UnitPrice)/1000000” to show revenue in millions of dollars, in accordance with a further embodiment of the present invention.

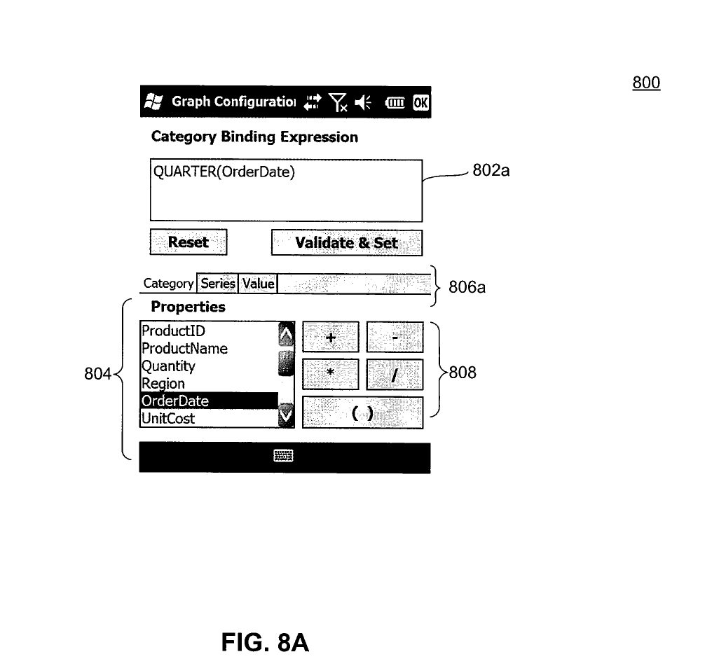

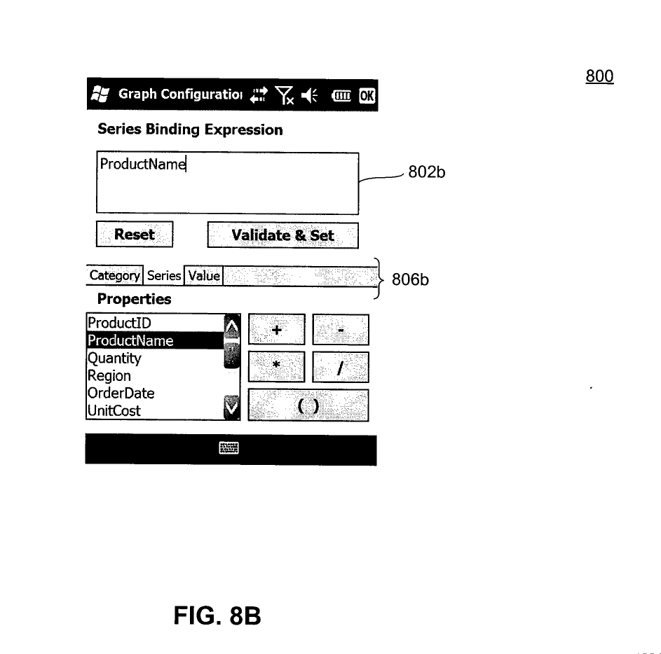

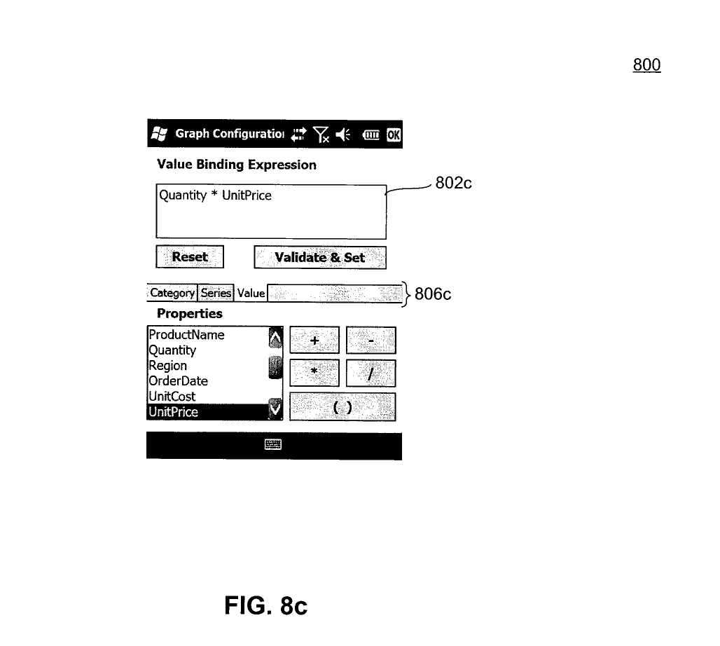

Selecting the “Advanced” button 710 of FIG. 7A allows a user with the proper role to access the advanced expression builder. FIG. 8 shows advanced expression builder 800, in accordance with an embodiment of the present invention. Expression field 802 shows the current expression which will be bound to the category field 704. Note that the “Category” tab in tab row 806a is the selected tab, indicating that the expression being customized is for the category. By selecting the “Series” (see FIG. 8B) or “Value” tabs (see FIG. 8C), an expression can be entered into field 802b and 802c for binding to the series or value, respectively. One skilled in the relevant arts will appreciate that similar expression creation techniques can be applied to the series and value of a graph as well. For example, FIG. 8B illustrates a series binding expression 802b, while FIG. 8C illustrates a value binding expression 802c. Moreover, one skilled in the relevant arts will appreciate that an expression for any particular category, value, or series may include zero or more properties and/or mathematical functions.

Properties list 804 shows properties from the underlying local database which can be used in the expression 802 that will be bound to category field 704, in accordance with an embodiment of the present invention. In accordance with a further embodiment of the present invention, properties list 804 is populated based on the meta data 210 of FIG. 2 definition of the local database. For example, the underlying database may not actually store an “OrderDate” as such, and may instead store a timestamp corresponding to the order. The meta data may define an interpretation of the timestamp which corresponds to a desired OrderDate output, such as a full month/day/year@ 24 hr time format. Regardless of how the data is presented, meta data 210 enables underlying local database fields to be readily available to a user in binding expressions using the expression builder.

Also on the display are several arithmetic operators 808 used in the creation of the expression 802. Although only basic arithmetic operators 808 are shown, more complex mathematical and statistical operations can be provided for use in expression building, and the basic arithmetic operators 808 are provided by way of example, and not limitation. As shown in element 220 of FIG. 2, functions used in prediction or statistical expressions can also be provided, in accordance with an embodiment of the present invention.

Using the advanced expression builder 800, a user is able to enter the complete expression, such as the expression for sales revenue shown in field 802, and validate it for usage in the creation of a graph.

A very powerful effect of providing expression builder 800 to a user is to allow the creation of new views of existing data on a local database without the need to rely on connectivity to an enterprise system. For example, if a user wishes to find profit per quarter, it would be possible to do so if the properties list provides for the quantity, unit price, and unit cost properties. A user could then enter the value expression “Quantity*(UnitPrice−UnitCost)”, and the graph would then have profit as binding expression for the “value.” If the category and series remain as in the previous examples (e.g., “QUARTER(OrderDate)” and “ProductName,” respectively), this would result in a graph showing profits per quarter for each product.

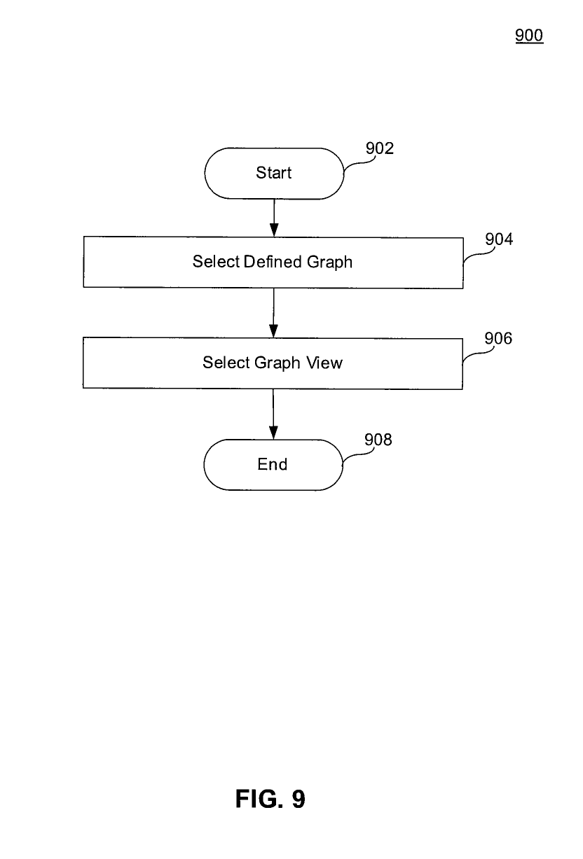

This powerful functionality is readily usable by a user who only wishes to view defined expressions in graphical form. FIG. 9 is a flowchart 900 illustrating steps by which a user is able to view a defined expression, in accordance with an embodiment of the present invention. The method starts at step 902 and proceeds to step 904 where the user selects a defined graph, corresponding to an expression, in accordance with an embodiment of the present invention. At step 904, if the user desires, it is possible to change the view of the graph. This allows the user to, for example, change the data view from a bar graph to a pie chart (see, e.g., FIGS. 5 and 6 showing changing a line chart to a bar chart). The method then ends at step 908.

Flowchart 900 therefore shows how simple the innovative thin analytics application is to use for a user who only wishes to view the results of several expressions. The facilities provided by the expression builder in such a scenario may therefore be useful to a developer wishing to present data customized to the nuances of this user. In accordance with an embodiment, a developer would use the expression builder (e.g., FIG. 8) to define and bind an expression to each data view. A busy sales manager may not have time to create all the views he might need, but using thin analytics he can specify the desired views to a developer, who can in turn rapidly use the expression builder to provide the requested views to the sales manager. In accordance with an embodiment of the present invention, the various views can be pushed to a mobile device from an enterprise server during a synchronization operation, such that a developer can rapidly anticipate and prepare expressions using the expression builder as they are needed by an end-user. All the end-user needs to do to take advantage of the expressions is to select the graph corresponding to the expression per step 904 of FIG. 9.

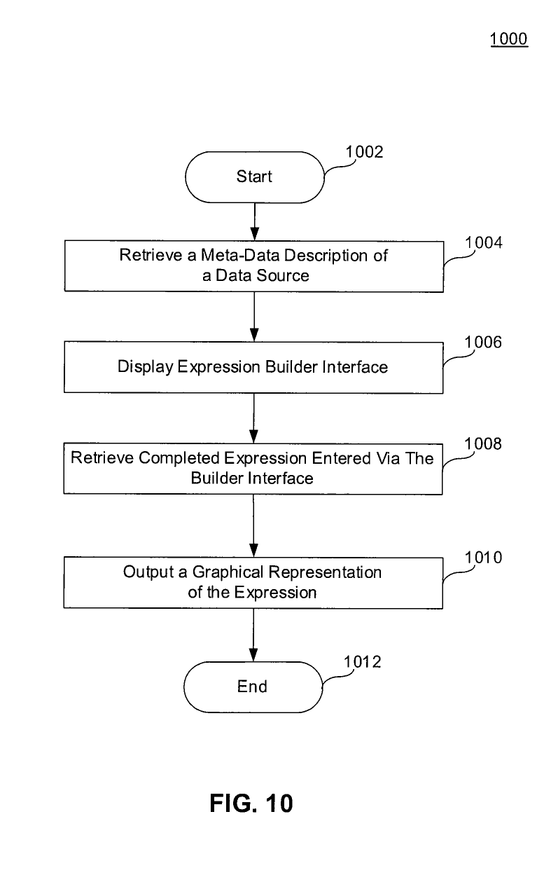

FIG. 10 is a flowchart 1000 illustrating steps by which the expression builder interface is usable to create an expression, in accordance with an embodiment of the present invention. The method begins at step 1002 and proceeds to step 1004 where a meta data description of a data source is obtained, in accordance with an embodiment of the present invention. This allows, for example, properties list 804 of FIG. 8 to be populated with various fields from the underlying data source, as previously discussed. At step 1006, the expression builder interface is displayed, such as the advanced expression builder interface 800 of FIG. 8, in accordance with an embodiment of the present invention.

At step 1008, a user, such as a developer, enters an expression in field 802, in accordance with an embodiment of the present invention. The expression in field 802 is then received by the thin analytics application from this field. In accordance with an embodiment of the present invention, the expression is stored in the local database for future use. In accordance with a further embodiment of the present invention, the expression is synchronized back with the enterprise server for use by other users.

The expression can then be selected at step 1010 for viewing. This is accomplished, in accordance with an embodiment of the present invention, by selecting a graph corresponding to the expression from a drop-down menu, such as menu 408 of FIG. 4B. The method ends at step 1012, having created an expression.

### V. User Roles

Users of the thin analytics application may be assigned to particular per-user or per-department roles. One skilled in the relevant arts will appreciate that additional ways to assign privileges for users exist, and the methods discussed herein are presented by way of example, and not limitation.

It is an advantage of the present invention that developers can readily create new views of data using the expression builder interface without the need to expose such functionality to a disinterested end-user. Particular views of data can be created on a per-user or per-department basis, and new views that would be useful can be quickly developed and deployed. Additionally, a power user role is defined, in accordance with an embodiment of the present invention, where interested users can take on the role of a developer and create their own expressions to develop new views of the local data.

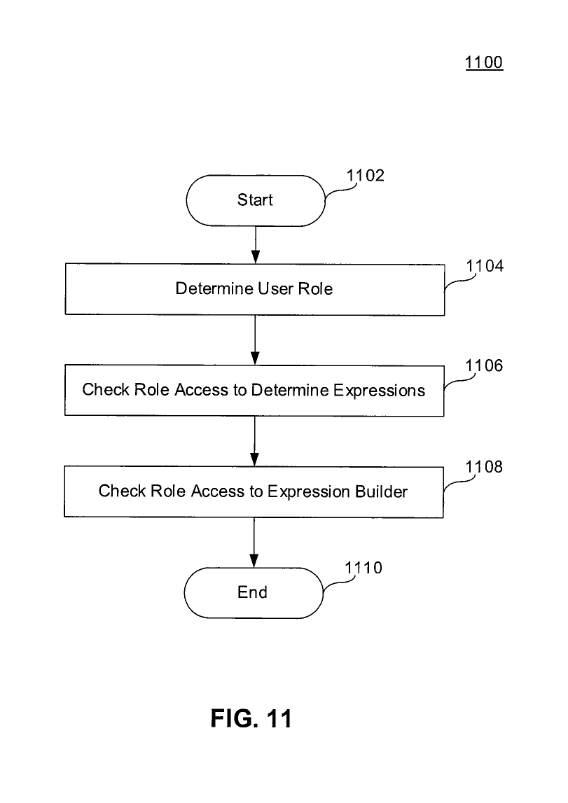

FIG. 11 is a flowchart 1100 illustrating steps by which user roles control access to the thin analytics application, in accordance with an embodiment of the present invention. The method begins at step 1102 and proceeds to 1104 where a user role is determined, in accordance with an embodiment of the present invention. As discussed above, this is only an exemplary privilege system implementation, and other implementations for assigning privileges to a user can be used.

At step 1106, the role's ability to access already-defined expressions is assessed. This allows, for example, expressions developed for users in the sales department and separate expressions developed for users in the warehouse to co-exist. Such expressions can all be pushed down to each of the mobile devices, in accordance with an embodiment of the present invention. In accordance with a further embodiment of the present invention, only the appropriate expressions are placed on the corresponding mobile devices. As a result, users associated with the sales group would only see expressions related to sales data, and users associated with the warehouse group would only see expressions related to warehouse operations, in accordance with an embodiment of the present invention.

Access to the expression builder and/or advanced expression builder is controlled at step 1108, in accordance with an embodiment of the present invention. This layer of protection hides the nuances of the expression builder from disinterested users and usergroups, while allowing power users and developers access to the expression builder. The method then ends at step 1110.

### VI. Example Computer System Implementation

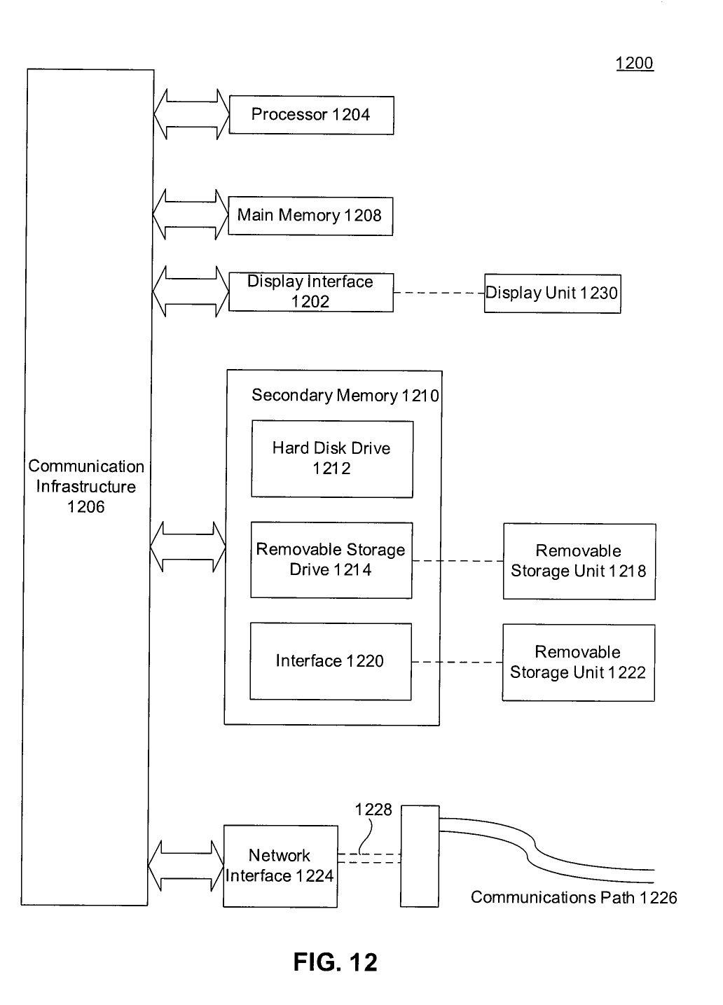

Various aspects of the present invention can be implemented by software, firmware, hardware, or a combination thereof. FIG. 12 illustrates an example computer system 1200 in which the present invention, or portions thereof, can be implemented as computer-readable code. For example, the methods illustrated by flowcharts 900 of FIG. 9, 1000 of FIG. 10, and 1100 of FIG. 11, can be implemented in system 1200. Various embodiments of the invention are described in terms of this example computer system 1200. After reading this description, it will become apparent to a person skilled in the relevant art how to implement the invention using other computer systems and/or computer architectures.

Computer system 1200 includes one or more processors, such as processor 1204. Processor 1204 can be a special purpose or a general purpose processor. Processor 1204 is connected to a communication infrastructure 1206 (for example, a bus or network).

Computer system 1200 also includes a main memory 1208, preferably random access memory (RAM), and may also include a secondary memory 1210. Secondary memory 1210 may include, for example, a hard disk drive 1212, a removable storage drive 1214, and/or a memory stick. Removable storage drive 1214 may comprise a floppy disk drive, a magnetic tape drive, an optical disk drive, a flash memory, or the like. The removable storage drive 1214 reads from and/or writes to a removable storage unit 1218 in a well known manner. Removable storage unit 1218 may comprise a floppy disk, magnetic tape, optical disk, etc. which is read by and written to by removable storage drive 1214. As will be appreciated by persons skilled in the relevant art(s), removable storage unit 1218 includes a computer usable storage medium having stored therein computer software and/or data.

In alternative implementations, secondary memory 1210 may include other similar means for allowing computer programs or other instructions to be loaded into computer system 1200. Such means may include, for example, a removable storage unit 1222 and an interface 1220. Examples of such means may include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to computer system 1200.

Computer system 1200 may also include a communications interface 1224. Communications interface 1224 allows software and data to be transferred between computer system 1200 and external devices. Communications interface 1224 may include a modem, a network interface (such as an Ethernet card), a communications port, a PCMCIA slot and card, or the like. Software and data transferred via communications interface 1224 are in the form of signals which may be electronic, electromagnetic, optical, or other signals capable of being received by communications interface 1224. These signals are provided to communications interface 1224 via a communications path 1226. Communications path 1226 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1218, removable storage unit 1222, and a hard disk installed in hard disk drive 1212. Signals carried over communications path 1226 can also embody the logic described herein. Computer program medium and computer usable medium can also refer to memories, such as main memory 1208 and secondary memory 1210, which can be memory semiconductors (e.g. DRAMs, etc.). These computer program products are means for providing software to computer system 1200.

Computer programs (also called computer control logic) are stored in main memory 1208 and/or secondary memory 1210. Computer programs may also be received via communications interface 1224. Such computer programs, when executed, enable computer system 1200 to implement the present invention as discussed herein. In particular, the computer programs, when executed, enable processor 1204 to implement the processes of the present invention, such as the steps in the methods illustrated by flowcharts 900 of FIG. 9, 1000 of FIG. 10, and 1100 of FIG. 11, discussed above. Accordingly, such computer programs represent controllers of the computer system 1200. Where the invention is implemented using software, the software may be stored in a computer program product and loaded into computer system 1200 using removable storage drive 1214, interface 1220, hard drive 1212 or communications interface 1224.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### VII. CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method comprising:
accessing, in one or more processors, a meta data description of a data source, the meta data description comprising data properties;
providing, in the one or more processors, an expression builder interface comprising a listing of the data properties and mathematical expressions usable in conjunction with the data properties;
receiving, in the one or more processors, an expression composed through the expression builder; and
graphically outputting, from the one or more processors to a display device, a representation of the expression based on data from the data source.

2. The method of claim 1, wherein the data source is fixed after deployment.

3. The method of claim 1, further comprising:
selecting the expression to be graphically output to the display device from a set of one or more defined expressions.

4. The method of claim 3, wherein the expression to be graphically output is selected from a drop-down menu.

5. The method of claim 1, further comprising:
receiving an access request for a set of one or more defined expressions, the access request associated with a user identifier;
determining a role associated with the user identifier; and
providing a subset of the set of one or more defined expressions for selection based on the role associated with the user identifier.

6. The method of claim 5, further comprising:
defining an associated role for the expression composed through the expression builder.

7. The method of claim 1, further comprising:
receiving an access request to define an expression, the access request associated with a user identifier;
determining a role associated with the user identifier; and
permitting access to the expression builder interface based on the role associated with the user identifier.

8. The method of claim 1, wherein receiving an expression composed through the expression builder comprises:
binding an expression defined for each of a category, series, and value of the representation of the expression.

9. The method of claim 8, wherein the representation of the expression comprises a graph, the method further comprising:
drawing the graph using the expressions defined for each of the category, series, and value responsive to the graph being selected for output.

10. A computer-readable medium having computer-executable instructions stored thereon that, if executed by a computing device, cause the computing device to perform a method comprising:
accessing a meta data description of a data source, the meta data description comprising data properties;
providing an expression builder interface comprising a listing of the data properties and mathematical expressions usable in conjunction with the data properties;
receiving an expression composed through the expression builder; and
graphically outputting a representation of the expression based on data from the data source.

11. The computer-readable medium of claim 10, wherein the data source is fixed after deployment.

12. The computer-readable medium of claim 10, the method further comprising:
selecting the expression to be graphically output to the display device from a set of one or more defined expressions.

13. The computer-readable medium of claim 12, wherein the expression to be graphically output is selected from a drop-down menu.

14. The computer-readable medium of claim 10, the method further comprising:
receiving an access request for a set of one or more defined expressions, the access request associated with a user identifier;
determining a role associated with the user identifier; and
providing a subset of the set of one or more defined expressions for selection based on the role associated with the user identifier.

15. The computer-readable medium of claim 14, the method further comprising:
defining an associated role for the expression composed through the expression builder.

16. The computer-readable medium of claim 10, the method further comprising:
receiving an access request to define an expression, the access request associated with a user identifier;
determining a role associated with the user identifier; and
permitting access to the expression builder interface based on the role associated with the user identifier.

17. The computer-readable medium of claim 10, wherein receiving an expression composed through the expression builder comprises:
binding an expression defined for each of a category, series, and value of the representation of the expression.

18. The computer-readable medium of claim 17, wherein the representation of the expression comprises a graph, the method further comprising:
drawing the graph using the expressions defined for each of the category, series, and value responsive to the graph being selected for output.

19. A system comprising:
a memory configured to store modules comprising:
an accessing module configured to access a meta data description of a data source, the meta data description comprising data properties,
a providing module configured to provide an expression builder interface comprising a listing of the data properties and mathematical expressions usable in conjunction with the data properties,
a receiving module configured to receive an expression composed through the expression builder, and
an outputting module configured to graphically output a representation of the expression based on data from the data source; and
one or more processors configured to process the modules.

20. A method comprising:
accessing, in one or more processors, a meta data description of a data source, the meta data description comprising data properties;
providing, in the one or more processors, an expression builder interface comprising a listing of the data properties and mathematical expressions usable in conjunction with the data properties;
receiving, in the one or more processors, an expression composed through the expression builder; and
transmitting the expression composed through the expression builder to a mobile device.
